(19) United States
(12) Patent Application Publication
(10) Pub. No.: US 2007/0019309 A1
(43) Pub. Date: Jan. 25, 2007

(54) SWITCHING ILLUMINATING SCISSORS

(75) Inventors: Phillip H. Neal, San Rafael, CA (US); Michael J. Liebowitz, Concord, CA (US); Margaret S. Neal, San Rafael, CA (US)

Correspondence Address: MICHAEL E. WOODS;PATENT LAW OFFICES OF MICHAEL E. WOODS, 112 BARN ROAD, TIBURON, CA, 94920-2602, US

(73) Assignee: Go Products, Inc., Greenbrae, CA (US)

(21) Appl. No.: 11/308,859

(22) Filed: May 16, 2006

Related U.S. Application Data
(60) Provisional application No. 60/594,938, filed on May 20, 2005.
(60) Provisional application No. 60/594,939, filed on May 20, 2005.
(60) Provisional application No. 60/594,940, filed on May 20, 2005.
(60) Provisional application No. 60/594,937, filed on May 20, 2005.

(51) Int. Cl. G02B 5/08

(52) U.S. Cl. 359/844

(57) ABSTRACT

An apparatus and method for improving local illumination by a cutting implement, such as scissors or shears and the like. The apparatus includes a pair of cooperating shear bodies rotatably coupled to each other about a pivot for opening and closing movements, each shear body including a blade having a pivot portion surrounding the pivot, a shank, and a finger grip; and an illumination system, coupled to the shear bodies and responsive to a rotational relationship between the shear bodies, for directing illumination into a field-of-view that includes the blades wherein the rotational relationship is established by a switch coupled to the blades.

### CROSS REFERENCE TO RELATED APPLICATIONS

The present application is related to and claims benefit from U.S. Application No. 60/594,937 entitled “Switching Illuminating Scissors” filed 20 May 2005, and is related to U.S. application Ser. No. ______ (Attorney Docket 20035-7010) entitled “Switching Illuminating Nail Clippers” filed concurrently that claims benefit from related U.S. Application No. 60/594,937 entitled “Switching Illuminating Nail Clippers,” filed 20 May 2005, and is related to U.S. application Ser. No. ______ (Attorney Docket 20035-7011) entitled “Switching Illuminating Tweezers With Magnifier” filed concurrently that claims benefit from related U.S. Application No. 60/594,940 entitled “Switching Illuminating Tweezers with Magnifier,” filed 20 May 2005, and is related to U.S. application Ser. No. ______ (Attorney Docket 20035-7013) entitled “Packaging Arrangement Having Package Feature For Biasing A Switch From An On Mode To An Off Mode,” filed concurrently that claims benefit from related U.S. Application No. 60/594,939 entitled “Packaging Arrangement Having Package Feature For Biasing A Switch From An On Mode To An Off Mode,” filed 20 May 2005, and each incorporated by reference in their entireties for all purposes.

### BACKGROUND OF THE INVENTION

The present invention relates generally to personal care products, and more specifically to illuminated implements for use by a caregiver when providing personal care to its charge.

Personal care products and tools have evolved and been developed for attending to personal hygiene of a human body. The evolution and development of these products and tools has largely been to enhance products for use by an individual in performance of their own personal care. When only a single person is involved, and that person controls the timing, urgency, and manner of performance of the product or tool, different parameters of the product or tool are optimized, created, emphasized and/or implemented.

However, when providing personal care for another person, particularly to a very young child or senior adult, the caregiver does not always control the timing, urgency, and manner of performance. Specifically, the caregiver may desire to provide various personal care procedures at times or locations that are not otherwise optimal. One common environmental factor that may not be able to be optimized in such situations is a level of ambient light in the vicinity of the procedure.

Besides these concerns, when providing personal care for another person, particularly to a very young child or senior adult, many caregivers prefer to enhance the level of care provided, including greater attention to safety procedures and use of safer tools. This is true even in situations where the caregiver may control some of the timing, urgency, and manner of performance, such as to increase a general level of ambient light. For this example, the caregiver may desire to precisely increase a level of illumination for use of personal care tool when a very young child or senior adult is involved.

Beyond these concerns, factors for acceptability and adoption of personal care procedures include ease of use, convenience, efficiency, and effectiveness. Portable illumination components (e.g., flashlights) have existed separate and distinct from tools so conventional systems either require coordination of the light source and a tool, or various forms of integration have been developed to mate a light to a tool. Some of the integration are simple physical connections that keep the tool and the light source together while others actually try to achieve a more synergistic combination. Maintaining ease of use, convenience, efficiency, and effectiveness becomes more challenging as multiple diverse functions are merged together. In the example of personal care applied to a young child or senior adult, enabling single-handed use and operation while providing the multiple diverse functions becomes increasingly difficult yet even more challenging. A caregiver often must use one hand for the tool and the other to interact with the young child or senior adult.

It should not be missed that improvements to procedures and tools that aid a care giver when attending to young children and senior adults may in many cases also assist in self-administration and self-care. Thus, it is a consideration that improvements to procedures and tools for administration to others not degrade or adversely affect self-administration.

One consequence of these factors is that some personal care products and tools are sometimes equipped with lights. Such conventional personal care products and tools have ON-OFF switches to control the light source independent from operation. The light for these devices is thus not always active and useful when the user operates the device. In some cases, operation of the device is delayed or interrupted while the light is manually illuminated. In other cases, the light is left on beyond the time of use because the switch was not manually returned to the off position, decreasing the longtime usefulness of the product or tool. Caregivers would prefer to have a product or tool that does not delay or interrupt their use, and one that does not have a premature end to its anticipated usefulness.

Today's consumer is inundated with offers to sell many different products and services, some of which may actually be of interest to the potential consumer. In some instances, interactive packaging (also sometimes referred to as “Try Me” packaging) may enhance an appeal of a product. For such products, it is advantageous to provide appropriate “Try Me” packaging. However, the state of the art does not permit a priori knowledge as to which products would be benefited from being packaged in an interactive format. Developing a superior product does not always equate with increased sales, at least until the market knows and understands the new product. There are many consumer products that incorporate microprocessors and microcontrollers that may include “Try Me” routines or programs that effectively address some of the concerns of “Try Me” packaging. However, for articles of manufacture that do not include electronic controllers, designing a product and its packaging to implement “Try Me” retailing is more challenging. Some conventional products have developed use of momentary switches or special multi-function switches so that a “continuous on” mode of the switch may be disabled by the packaging while providing access to an “On while pressed” mode of the switch.

What is needed are personal care products, tools, and procedures that address and overcome the deficiencies of the current products and tools; specifically what is needed are products, tools, and procedures for simply and efficiently increasing a level of illumination at the operational point of personal care products, tools, and procedures. Additionally, designing such products, tools, and procedures so that they include features or functions that may be emphasized in suitable interactive packaging is also beneficial.

### BRIEF SUMMARY OF THE INVENTION

Disclosed is an apparatus and method for improving local illumination by a cutting implement, such as scissors or shears and the like. The apparatus includes a pair of cooperating shear bodies rotatably coupled to each other about a pivot for opening and closing movements, each shear body including a blade having a pivot portion surrounding the pivot, a shank, and a finger grip; and an illumination system, coupled to the shear bodies and responsive to a rotational relationship between the shear bodies, for directing illumination into a field-of-view that includes the blades wherein the rotational relationship is established by a switch coupled to the blades.

Preferred embodiments of the present invention include personal care products, tools, and procedures that address and overcome the deficiencies of the current products and tools; specifically products, tools, and procedures that simply and efficiently increase a level of illumination at the operational point of personal care products, tools, and procedures. Additionally, the preferred embodiments include features or functions that may be emphasized in suitable interactive packaging.

### BRIEF DESCRIPTION OF THE DRAWINGS

FIG. 1 is a lateral view of a preferred embodiment of the present invention for an illuminating scissors in an open configuration.

### DETAILED DESCRIPTION OF THE INVENTION

The present invention provides an apparatus and method for an illuminating cutting implement (e.g., scissors, shears and the like) as well as implementation of a design paradigm for enabling “Try Me” retail packaging with a function controlled by physical manipulation of a handle or lever included as part of the product. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

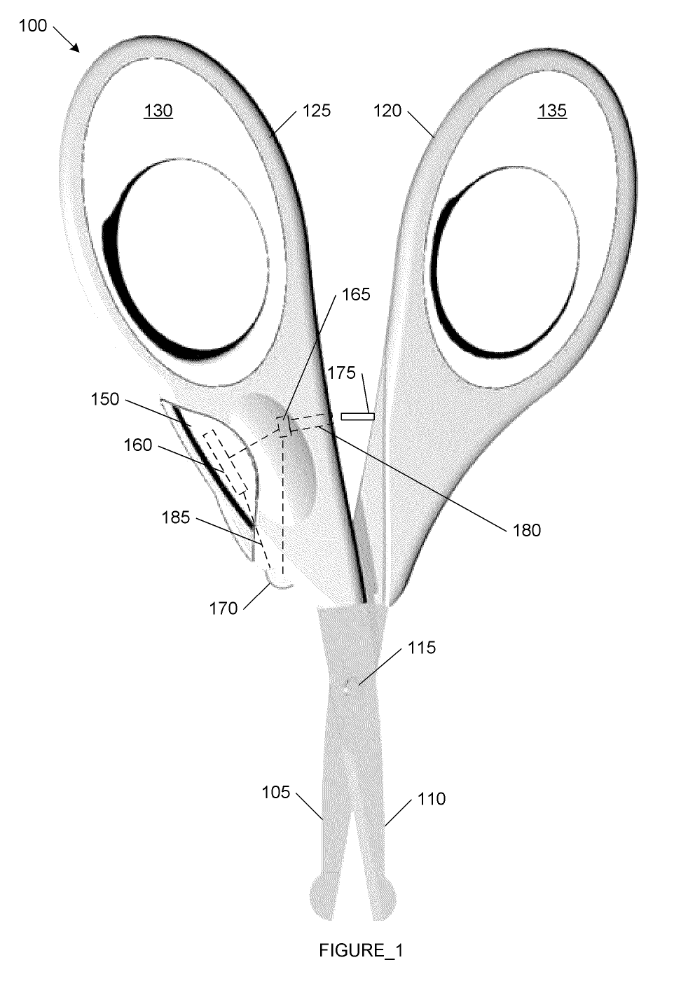

FIG. 1 is a lateral view of a preferred embodiment of the present invention for an illuminating scissors 100 in an open configuration. Scissors 100 includes a first shear body 105, a second shear body 110, a shank 115, a first handle 120 coupled to first shear body 105, and a second handle 125 coupled to second shear body 110. The shear bodies include cooperating cutting edges, with body 105, body 110, shank 115, handle 120, and handle 125 conventionally interconnected to produce a scissoring/shearing cutting implement. This implement, as shown, is configured for cutting thin materials (e.g., paper, cardboard, metal foil, thin plastic, food, cloth, thread, rope, wire, hair, nails, and the like) but as well-known, other configurations for the bodies, shank, and handles may be adapted to cut other materials, for example sheet metal, branches, shrubbery, heavy wire, bolts, tile, and the like.

Scissors 100 includes, in addition to the components of the scissoring/shearing cutting implement, a molded thumb grip 130, a molded finger grip 135, and an illumination subsystem that includes a housing 150 containing a battery 160 and a switch 165 for controlling an illumination source 170 (such as a white LED) in response to a switch trigger 175. When scissors 100 are fully closed and the handles are proximate each other, trigger 175 engages switch 165 through aperture 180 to deactivate illumination source 170. When scissors 100 are partially-opened to fully-opened, trigger 175 disengages from switch 165 to activate illumination source 170. In the preferred embodiment, it is desirable that only a slightest separation of handle 120 from handle 125 disengages trigger 175. For most users, during cutting operations scissors are never fully closed. For these users, illumination source 170 remains illuminated during use, with source 170 automatically turned off when the user is done with scissors 100 and closes them fully. In some cases, it may be desirable to include an “OFF” delay in switch 165 (such as by including a capacitor for example) to maintain source 170 illuminated for a short period after scissors 100 are fully closed.

In the preferred embodiments, the grips are adapted to enhance the cutting experience, which may include widening, lengthening, conforming, and other modifications to the grip dimensions, as well as material selection (e.g., cushioning) to enhance operation of the cutting subsystem.

Source 170 is located at a forward leading edge of handle 125 so that, when active, source 170 illuminates portions of the shear bodies beyond shank 115. Engaging an operational mode of the illumination subsystem (in the preferred embodiment, by opening scissors 100) activates source 170 located at a position between a user and the cutting edges to illuminate a field-of-view that includes the cutting edges and some distance in front and to the sides. In the preferred embodiment, source 170 is powered by battery 160 and an ON/OFF status of source 170 is controlled by switch 165, interacting with trigger 175. Switch 165 responds to trigger 175 so movement of the handles controls switch operation.

A threshold for determining the ON/OFF responsiveness of switch 165 varies in different embodiments and implementations, however the preferred embodiment (switch 165 activates source 170 within a few degrees of separation) more easily permits use of a package-enhancing features during marketing, such as a “Try Me” package. Thus the features of incorporating switch 165 into scissors 100 in a manner that source 170 is responsive to operational deployment and establishing thresholds for ON/OFF responsiveness so that a desired feature (in this case illumination) is enabled during a small end-portion of boom-deploying rotation, combines to produce in this implementation characteristics for scissors 100 that enable consumer-level retail “Try Me” packaging. (Such as, for example, providing packaging that lightly biases the handles into a rotational position close to the threshold, but with source 170 inactive.) The packaging, in permitting a prospective customer to further separate the handles past the threshold to activate source 170 interactively presents the illumination feature, but returns source 170 to the inactive status when the prospective customer is done interacting with the packaging. Providing the triggering close to the threshold, near the extreme end of range of movement, and using a lever arm, permits the biasing mechanism in the packaging to be implemented efficiently and inexpensively. For example, foam may be adhered to appropriate portions of a package in contact with the actuating handle. Other biasing systems, e.g., metal springs and the like, may also be used. This configuration permits light force, short distance biasing systems to be used that are often quite simple, effective, virtually error-free, and inexpensive.

Additionally, FIG. 1 illustrates an electrically conductive path 185 that forms an electrical circuit for battery 160, switch 165 and source 170. Current in this electrical circuit is controlled by switch 165, and switch 165 is controlled in turn by trigger 175 responsive to a positional rotation of the handles.

In operation, a user opens scissors 100 by moving the handles to permit cutting operations. Switch 165, sometime during these movements of the handles as determined by design considerations specific to an embodiment and implementation, closes conductive path 185 to cause battery 160 to produce an electrical potential across source 170 so that source 170 illuminates the cutting zone. When cutting is complete, the user closes the handles together, opening path 185 and extinguishing source 170.

Other variations and modifications are possible without departing from the spirit and scope of the present invention, some of these variations and modifications are described above, Other variations and modifications include changes to battery location and a location/operation of source 170 or switch 165. Source 170 variations may include differences in stowage/operational locations (e.g., illuminating from a location near a rear of the housing and the like). Switch 165 variations may include other triggering systems for responding to a relative rotational orientation of the handles. For example, switch 165 may be implemented by integrating switching functions into conductive (e.g., metal) shear bodies around shank 115 and the proximate pivot. Providing portions of the mating surfaces of the inside of the shear bodies with conductive and nonconductive elements and arranging the non-conductive elements so they overlap when the handles have the desired relative rotational orientation (e.g., close to closing) and that the conducting portions overlap when the handles have a second desired rotational orientation (e.g., open beyond the desired (e.g. small) threshold) so that the elements form switch 165 provides an alternative control system.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope of the present invention to implement a program or code that may be stored in a machine-readable medium or transmitted using a carrier wave to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

The above-described arrangements of apparatus and methods are merely illustrative of applications of the principles of this invention and many other embodiments and modifications may be made without departing from the spirit and scope of the invention as defined in the claims.

These and other novel aspects of the present invention will be apparent to those of ordinary skill in the art upon review of the drawings and the remaining portions of the specification. Therefore, the scope of the invention is to be determined solely by the appended claims.

What is claimed as new and desired to be protected by Letters Patent of the United States is:

1. An apparatus, comprising:
a pair of cooperating shear bodies rotatably coupled to each other about a pivot for opening and closing movements, each shear body including a blade having a pivot portion surrounding said pivot, a shank, and a finger grip; and
an illumination system, coupled to said shear bodies and responsive to a rotational relationship between said shear bodies, for directing illumination into a field-of-view that includes said blades
wherein said rotational relationship is established by a switch coupled to said blades.

2. The apparatus of claim 1 wherein said switch is integrated into said pivot portions of said blades.

3. The apparatus of claim 2 wherein said pivot portions include a conducting subportion and a non-conducting subportion wherein said non-conducting subportions are proximate each other when said pair of cooperating shear bodies have a first relationship and wherein said conducting subportions are contacting each other when said pair of cooperating shear bodies have a second relationship.

4. The apparatus of claim 3 wherein said first relationship defines a substantially closed relationship of said cooperating shear bodies and wherein said second relationship defines a relationship other than said first relationship.

5. The apparatus of claim 1 wherein said illumination system includes a light source for providing said illumination; and
a battery for powering said light source responsive to said switch.

6. The apparatus of claim 5 wherein said switch is integrated into said pivot portions of said blades.

7. The apparatus of claim 6 wherein said pivot portions include a conducting subportion and a non-conducting subportion wherein said non-conducting subportions are proximate each other when said pair of cooperating shear bodies have a first relationship and wherein said conducting subportions are contacting each other when said pair of cooperating shear bodies have a second relationship.

8. The apparatus of claim 7 wherein said first relationship defines a substantially closed relationship of said cooperating shear bodies and wherein said second relationship defines a relationship other than said first relationship.

9. The apparatus of claim 1 wherein said switch is integrated into a portion of a first one of said shear bodies and wherein said switch is actuated by a switch trigger provided into a portion of a second one of said shear bodies.

10. A method, the method comprising:
a) providing a scissors with an illumination subsystem integrated into a handle wherein said illumination subsystem is responsive to a switch coupled to a handle;
b) actuating said illumination subsystem by positioning said handle into an operational mode that directs illumination from said illumination subsystem into a field-of-view that includes a cutting edge of said scissors.

11. The method of claim 10 wherein said handle includes an illumination boom supporting a light source.

12. The method of claim 11 wherein said light source is actuated by a switch trigger and switch interaction.

13. The method of claim 12 wherein said switch trigger is disposed in a portion of said scissors that moves with cutting operations of said scissors.

14. The method of claim 12 wherein said light source is activated within about five degrees of an end of a range of rotation for said illumination boom.
